(19) United States
(12) Patent Application Publication
(10) Pub. No.: US 2019/0386774 A1
(43) Pub. Date: Dec. 19, 2019

(54) Communication Method and System

(71) Applicants: Guoxia Zhang, Shanghai (CN); Qingshan Zhang, Shanghai (CN); Zeng Yang, Shanghai (CN)

(72) Inventors: Guoxia Zhang, Shanghai (CN); Qingshan Zhang, Shanghai (CN); Zeng Yang, Shanghai (CN)

(73) Assignee: Harman International Industries, Incorporated, Stamford, CT (US)

(21) Appl. No.: 16/465,744

(22) PCT Filed: Dec. 2, 2016
(86) PCT No.: PCT/IB2016/057290

§ 371 Date: May 31, 2019

(51) Int. Cl. H04L 1/00; H04L 29/06

(52) U.S. Cl. CPC H04L 1/0042; H04L 1/0076; H04L 2025/03789; H04L 1/0045; H04L 69/16

(57) ABSTRACT

A communication method and system for reducing computational overhead by obtaining N native data packets; encoding the N native data packets into M encoded data packets using M linearly independent coefficient vectors respectively, where the M linearly independent coefficient vectors are selected from a look up table based on N and M; and sending, through a network, the M encoded data packets, where N≥1 and M≥1.

### TECHNICAL FIELD

The present disclosure generally relates to communication method and system based on network coding.

### BACKGROUND

Network coding has emerged as an approach to the operation of communication networks, especially wireless networks. In this scheme, a network coding layer is embedded below Transmission Control Protocol (TCP) layer and above Internet Protocol (IP) layer on a source side or a receiver side to improve the capacity and efficiency of network transmissions. However, the computational overhead of the network coding layer is high.

### SUMMARY

In one embodiment, a communication method is provided. The method may include: obtaining N native data packets; encoding the N native data packets into M encoded data packets using M linearly independent coefficient vectors respectively, where the M linearly independent coefficient vectors are selected from a look up table based on N and M; and sending, through a network, the M encoded data packets, where N≥1 and M≥1.

In some embodiments, at least one of the M encoded data packets may have a header which contains a piece of information indicating N and M.

In some embodiments, M may be determined based on a packet loss rate of the network and N.

In some embodiments, each of the M encoded data packets may have a header which contains a sequence number of the encoded data packet.

In one embodiment, a communication method is provided. The method may include: receiving, through a network, R encoded data packets at least one of which has a header which contains a piece of information indicating N and M, where N stands for the number of native packets based on which the R encoded data packets are generated, and M stands for the total number of encoded data packets which are generated based on the N native data packets; selecting R linearly independent coefficient vectors from a look up table based on N and M; and decoding the R encoded data packets using the R linearly independent coefficient vectors to obtain the N native packets.

In some embodiments, each of the R encoded data packets may have a header which contains a sequence number of the encoded data packet, and the R linearly independent coefficient vectors may be selected based on N, M and sequence numbers of the R encoded data packets.

In one embodiment, a communication system is provided, the system may include a transceiver and a processing device configured to: obtain N native data packets; encode the N native data packets into M encoded data packets using M linearly independent coefficient vectors respectively, where the M linearly independent coefficient vectors are selected from a look up table based on N and M; and control the transceiver to send, through a network, the M encoded data packets, where N≥1 and M≥1.

In some embodiments, at least one of the M encoded data packets may have a header which contains a piece of information indicating N and M.

In some embodiments, M may be determined based on a packet loss rate of the network and N.

In some embodiments, each of the M encoded data packets may have a header which contains a sequence number of the encoded data packet.

In one embodiment, a communication system is provided. The system may include a transceiver and a processing device configured to: after the transceiver receives, through a network, R encoded data packets at least one of which has a header which contains a piece of information indicating N and M, select R linearly independent coefficient vectors from a look up table based on N and M, where N stands for the number of native packets based on which the R encoded data packets are generated, and M stands for the total number of encoded data packets which are generated based on the N native data packets; and decode the R encoded data packets using the R linearly independent coefficient vectors to obtain the N native data packets.

In some embodiments, each of the R encoded data packets may have a header which contains a sequence number of the encoded data packet, and the R linearly independent coefficient vectors may be selected based on N, M and sequence numbers of the R encoded data packets.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered as limitation to its scope, the disclosure will be described with additional specificity and detail through use of the accompanying drawings.

FIG. 1 illustrates a schematic flow chart of a communication method according to one embodiment;

FIG. 2 schematically illustrates a network coding protocol stack according to one embodiment;

FIG. 3 schematically illustrates contents of a header according to one embodiment; and

FIG. 4 illustrates a schematic block diagram of a communication system according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limitation. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

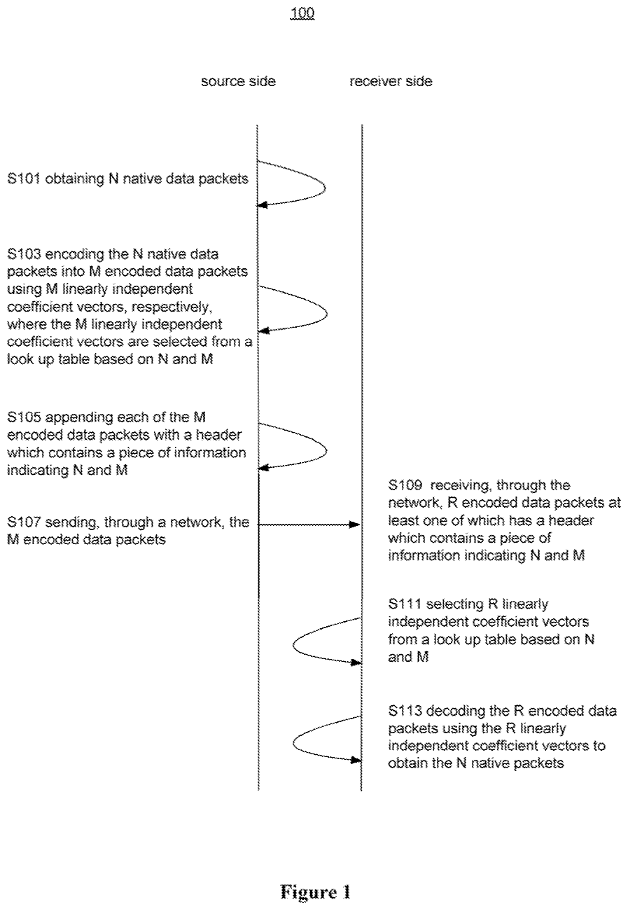

FIG. 1 illustrates a schematic flow chart of a communication method 100 according to one embodiment.

In S101, obtaining N native data packets.

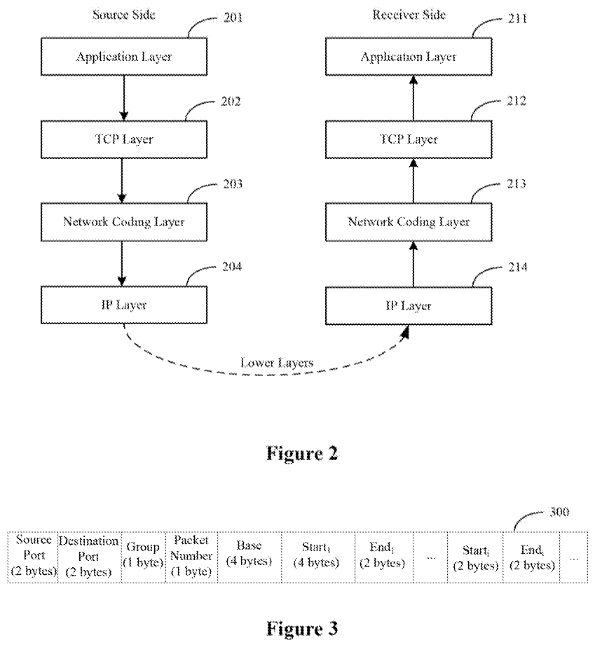

FIG. 2 schematically illustrates a network coding protocol stack according to one embodiment. Referring to FIG. 2, the network coding protocol stack on a source side includes an application layer 201, a Transmission Control Protocol (TCP) layer 202, a network coding layer 203 and an Internet Protocol (IP) layer 204. The network coding layer 203 is embedded below the TCP layer 202 and above the IP layer 204. In some embodiments, the network coding layer 203 on the source side may receive the N native data packets from the TCP layer 202. In some embodiments, the network coding layer 203 on the source side may buffer the N native data packets into an encoding buffer.

In S103, encoding the N native data packets into M encoded data packets using M linearly independent coefficient vectors respectively, where the M linearly independent coefficient vectors are selected from a look up table based on N and M.

The M encoded data packets may be sent to a receiver side in subsequent steps. Due to the random packet loss of the network, the value of M should be chosen carefully, so that the receiver side can receive enough encoded data packets to obtain the N native data packets. In some embodiments, M may be greater than N. In some embodiments, M may be determined based on a packet loss rate of the network and N.

In some embodiments, M may be calculated by Equation (1):

M=N/(1−Pₑ) Equation (1)

where Pₑ represents the packet loss rate of the network.

After M is determined, M linearly independent coefficient vectors may be selected from a look up table based on N and M. In some embodiments, a look up table is stored in the source side. The look up table includes a plurality of sets of linearly independent coefficient vectors. Each set of linearly independent coefficient vectors corresponds to a different pair of native data packet quantity and encoded data packet quantity. An example of the look up table is shown in Table 1. For example, if M=M₄ and N=N₃, M linearly independent coefficient vectors in a set of S43 may be selected.

TABLE 1

| | N1 | N2 | N3 | . . . | Nj |
|---|---|---|---|---|---|
| M1 | S11 | S12 | S13 | . . . | S1j |
| M2 | S21 | S22 | S23 | . . . | S2j |
| M3 | S31 | S32 | S33 | . . . | S3j |
| M4 | S41 | S42 | S43 | . . . | S4j |
| . . . | . . . | . . . | . . . | . . . | . . . |
| Mi | Si1 | Si2 | Si3 | | Sij |

As described above, because the M linearly independent coefficient vectors are selected from the look up table, linearly independent estimation processes performed on the coefficient vectors are not needed. Therefore, the computational overhead on the source side is reduced.

Then, the network coding layer 203 may encode the N native data packets into M encoded data packets using the M linearly independent coefficient vectors respectively. In some embodiments, each of the M encoded data packets is a linear combination of the N native packets based on a corresponding linearly independent coefficient vector of the M linearly independent coefficient vectors. For example, each of the M encoded data packets are obtained by Equation (2):

q=Σᵢ₌₁^{i=N}αᵢpᵢ Equation (2)

where q represents one of the M encoded data packets, pᵢ represents an i^{th} data packet of the N native data packets, and αᵢ represents an i^{th} element of a corresponding coefficient vector.

In S105, appending each of the M encoded data packets with a header which contains a piece of information indicating N and M.

FIG. 3 schematically illustrates a header 300 appended to each of the M encoded data packets according to one embodiment. Referring to FIG. 3, the header 300 includes a 1-byte “Group” field. The “Group” field may be used to identify a specific combination of N and M. For example, a 4-bits sub-field of the “Group” field is used to represent N, and the other 4-bits sub-field of the “Group” field is used to represent M.

Referring to FIG. 3, in some embodiments, the header 300 further includes a 2-bytes “Source Port” field, a 2-bytes “Destination Port” field, a 1-byte “Packet Number” field and a 4-bytes “Base” field. The “Source Port” and the “Destination Port” are needed for the receiver side to identify which TCP connection the data packet corresponds to. In some embodiments, the “Source Port” and the “Destination Port” are taken out of a TCP header of a corresponding native data packet and are included in the header 300. The “Packet Number” field is used to identify a sequence number of the encoded data packet in the M encoded data packets. The “Base” field indicates a TCP byte sequence number of a first byte that has not been acknowledged. In some embodiments, the “Base” field may be used by the source side or the receiver side to decide which data packet can be safely dropped from its buffer without affecting reliability.

In some embodiments, the header 300 may further include N “Startᵢ” fields and N “Endᵢ” fields. For encoding operations on the source side, the N native data packets are adjusted to have a fixed packet length. The “Startᵢ” field may indicate the starting byte of an i^{th} data packet in a corresponding fixed-length data packet, and the “Endᵢ” field may indicate the last byte of the i^{th} data packet in the corresponding fixed-length data packet.

In S107, sending, through the network, the M encoded data packets.

As shown in FIG. 2, in some embodiments, the network coding layer 203 may send the M encoded data packets to the IP layer 204, and the IP layer 204 may send the M encoded data packets through lower layers.

At the receiver side, instead of the N native data packets, encoded data packets may be received.

In S109, receiving, through the network, R encoded data packets at least one of which has a header which contains a piece of information indicating N and M.

As shown in FIG. 2, the network coding protocol stack on the receiver side may include an application layer 211, a TCP layer 212, a network coding layer 213 and an IP layer 214. The network coding layer 213 is embedded below the TCP layer 212 and above the IP layer 214 on the receiver side. In some embodiments, the IP layer 214 on the receiver side may receive the R encoded data packets from lower layers, and send the R encoded data packets to the network coding layer 213. In some embodiments, the network coding layer 213 on the receiver side may buffer the R encoded data packets into a decoding buffer.

Because the random packet loss of the network, maybe not all of the M encoded data packets sent by the source side can be received by the receiver side. Until the number of the encoded data packets in the decoding buffer reaches N, the N native data packets can be obtained by decoding the encoded data packets. That is, R should be equal to or greater than N.

In some embodiments, at least one of the R encoded data packets may have a header which contains a piece of information indicating N and M. An example of the header is shown in FIG. 3, and the “Group” field of the header 300 may be used to identify the specific combination of N and M. N stands for the number of native packets based on which the R encoded data packets are generated, and M stands for the total number of encoded data packets which are generated based on the N native data packets.

In S111, selecting R linearly independent coefficient vectors from a look up table based on N and M.

After receiving an encoded data packet, the network coding layer 213 may unpack the header appended to the encoded data packet, so as to obtain N and M in the “Group” field. In some embodiments, a look up table, which is the same as the look up table in the source side, is stored in the receiver side. The look up table includes a plurality of sets of linearly independent coefficient vectors. Each set of linearly independent coefficient vectors corresponds to a different pair of N and M. The network coding layer 213 may search the look up table to obtain a set of linearly independent coefficient vectors based on N and M.

Moreover, as shown in FIG. 3, the header 300 of each encoded data packet may include a “packet number” field. The network coding layer 213 may further obtain R sequence numbers of the R encoded data packets from the “Packet Number” fields. The network coding layer 213 may further select R linearly independent coefficient vectors from the selected set of linearly independent coefficient vectors based on the R sequence numbers.

Since coefficient vectors in the look up table are predetermined and linearly independent, linearly independent estimation processes performed on the R coefficient vectors are not needed. Therefore, the computational overhead on the receiver side is reduced.

In S113, decoding the R encoded data packets using the R linearly independent coefficient vectors to obtain the N native packets.

In some embodiments, the R linearly independent coefficient vectors may be put into a coefficient matrix. In some embodiments, the network coding layer 213 may invert the coefficient matrix using Gaussian elimination, and apply linear combination operations on the R encoded data packets to obtain N adjusted data packets with a fixed-length. Thereafter, based on the “Startᵢ” fields and “Endᵢ” fields in the header 300 as shown in FIG. 3, the first byte and the last byte of the ith native data packet in the corresponding adjusted data packet may be determined, and the ith native data packet can be obtained.

Thereafter, as shown in FIG. 2, the network coding layer 213 on the receiver side may send the N native data packets to the TCP layer 212 based on information of the “Destination Port” field in the header 300.

As described above, the linearly independent coefficient vectors are selected from a look up table based on N and M. Therefore, linearly independent estimation processes on both the source side and the receiver side are not necessary so that the computational overhead is reduced. Furthermore, the header of the encoded data packet doesn't contain the corresponding coefficient vector, so that the network overhead is reduced.

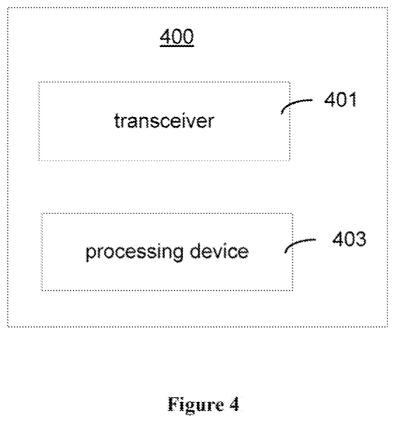

According to one embodiment, a communication system is provided. The communication system may be disposed at a source side or a receiver side in a network. FIG. 4 illustrates a schematic block diagram of the communication system 400 according to one embodiment. The communication system 400 may includes a transceiver 401 and a processing device 403.

If the communication system 400 is disposed at a source side. The processing device 403 may be configured to: obtain N native data packets; encode the N native data packets into M encoded data packets using M linearly independent coefficient vectors respectively, where the M linearly independent coefficient vectors are selected from a look up table based on N and M; and control the transceiver 401 to send, through a network, the M encoded data packets, where N≥1 and M≥1. Detail configurations of the processing device 403 may be obtained by referring detail descriptions in S101 to S107.

If the communication system 400 is disposed at a receiver side. The processing device 403 may be configured to: after the transceiver 401 receives, through a network, R encoded data packets at least one of which has a header which contains a piece of information indicating N and M, select R linearly independent coefficient vectors from a look up table based on N and M, where N stands for the number of native packets based on which the R encoded data packets are generated, and M stands for the total number of encoded data packets which are generated based on the N native data packets; and decode the R encoded data packets using the R linearly independent coefficient vectors to obtain the N native data packets. Detail configurations of the processing device 403 may be obtained by referring detail descriptions in S109 to S113.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A communication method, comprising:
obtaining N native data packets;
encoding the N native data packets into M encoded data packets using M linearly independent coefficient vectors respectively, where the M linearly independent coefficient vectors are selected from a look up table based on N and M; and
sending, through a network, the M encoded data packets, where N≥1 and M≥1.

2. The method according to claim 1, wherein at least one of the M encoded data packets has a header which contains a piece of information indicating N and M.

3. The method according to claim 1, wherein M is determined based on a packet loss rate of the network and N.

4. The method according to claim 1, wherein each of the M encoded data packets has a header which contains a sequence number of the encoded data packet.

5. A communication method, comprising:
receiving, through a network, R encoded data packets at least one of which has a header which contains a piece of information indicating N and M, where N stands for the number of native packets based on which the R encoded data packets are generated, and M stands for the total number of encoded data packets which are generated based on the N native data packets;
selecting R linearly independent coefficient vectors from a look up table based on N and M; and
decoding the R encoded data packets using the R linearly independent coefficient vectors to obtain the N native packets.

6. The method according to claim 5, wherein each of the R encoded data packets has a header which contains a sequence number of the encoded data packet, and the R linearly independent coefficient vectors are selected based on N, M and sequence numbers of the R encoded data packets.

7. A communication system, comprising a transceiver and a processing device configured to:
obtain N native data packets;
encode the N native data packets into M encoded data packets using M linearly independent coefficient vectors respectively, where the M linearly independent coefficient vectors are selected from a look up table based on N and M; and
control the transceiver to send, through a network, the M encoded data packets, where N≥1 and M≥1.

8. The system according to claim 7, wherein at least one of the M encode data packets has a header which contains a piece of information indicating N and M.

9. The system according to claim 7, wherein M is determined based on a packet loss rate of the network and N.

10. The system according to claim 7, wherein each of the M encoded data packets has a header which contains a sequence number of the encoded data packet.

11. (canceled)

12. (canceled)
